(19) United States
(12) Patent Application Publication
(10) Pub. No.: US 2018/0039828 A1
(43) Pub. Date: Feb. 8, 2018

(54) GENERATING A SIGNED ELECTRONIC DOCUMENT

(71) Applicant: FUJI XEROX AUSTRALIA PTY LIMITED, New South Wales (AU)

(72) Inventor: Matthew COAD, New South Wales (AU)

(21) Appl. No.: 15/551,909

(22) PCT Filed: Feb. 17, 2016
(86) PCT No.: PCT/AU2016/050104

§ 371 Date: Aug. 18, 2017

(30) Foreign Application Priority Data
Feb. 18, 2015 (AU) 2015200816

(51) Int. Cl. G06K 9/00; G06F 3/0482; G06F 3/0488; G06Q 50/18; H04L 9/32

(52) U.S. Cl. CPC G06K 9/00442; G06Q 50/18; H04L 9/3247; G06F 3/04883; G06F 3/0482; G06Q 10/10

(57) ABSTRACT

A computer-implemented method (200) for generating a signed electronic document, the method comprising: identifying (210) one or more predetermined features in document content data, wherein the document content data forms at least part of an electronic document to be signed; selecting (210), based on the one or more identified features, one or more routines from a plurality of routines, where at least one of the one or more routines defines supplementary information associated with one or more predetermined features; performing (230) the selected one or more routines to provide at a user interface a representation of the supplementary information, where the representation of the supplementary information is in addition to a representation of the electronic document at the user interface; receiving (240) a signature of a user at the user interface; and generating (250) the signed electronic document by associating the electronic document with the signature.

### TECHNICAL FIELD

The present disclosure relates to computer-implemented methods, computer systems, computing devices and computer programs for generating a signed electronic document.

### BACKGROUND

Keeping documented records of acts, agreements, deeds, contracts, transactions, statements, declarations and other activities by one or more parties are important legally and commercially. Traditionally, such documents include paper documents with written text conveying information to be recorded. Relevant person(s) may provide a written signature by hand to execute or confirm the information on the document. Providing a signature may be a requirement and/or proof of the party acknowledging and agreeing to the document. Documents that are provided in a physical form, such as paper documents mentioned above, are known as “hard copy”.

Ideally, a party signing a document should carefully read all written text on the document. However, some documents are particularly long and it may not be practical for a person to read all the written text in detail. In some instances, a person may be required to execute a document on a regular basis with one or more portions of the document that changes from time to time. In other instances, a document may include one or more portions that are more important than the remaining portions. In yet another instance, a document may have reference to additional information from another source, where the additional information is not contained within the document. This may include, for example, an invoice or receipt that refers to “terms and conditions” contained in another document.

The use of computers, associated communication networks, emails and cloud based computing and storage have led to the increased use of electronic documents. Such electronic documents (such as electronic documents in memory, on a digital storage medium, or stored in storage associated with a server) are often referred to as “soft copy”. Although such electronic documents are capable of being printed on a printer to produce a hard copy of the document, it may be desirable to have documents in electronic form. For example, an electronic document may be easily and quickly disseminated to one or more parties, for example by electronic mail. Furthermore, an electronic document may have a backup on one or more datastores or servers and the corruption or destruction of one copy of an electronic document may be curable since the backup copy may be retrieved. In addition, an electronic document, in itself, does not require physical paper. Thus use of electronic documents in soft copy form may reduce the use of paper resources which is better for the environment.

Traditional hard copy documents may be scanned to provide soft copy electronic documents. However this would require the hard copy document to be printed in the first place which can add to financial and environmental costs. Furthermore, scanning hard copy documents to provide soft copy electronic documents may create more work on administrative staff.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

The present disclosure provides a computer-implemented method for generating a signed electronic document, the method including: identifying one or more predetermined features in document content data, wherein the document content data forms at least part of an electronic document to be signed; selecting, based on the one or more identified features, one or more routines from a plurality of routines, where at least one of the one or more routines defines supplementary information associated with one or more predetermined features; performing the selected one or more routines to provide at a user interface a representation of the supplementary information, where the representation of the supplementary information is in addition to a representation of the electronic document at the user interface; receiving a signature of a user at the user interface; and generating the signed electronic document by associating the electronic document with the signature.

An advantage of the method may include allowing a user to review the content of the document before signing. Another advantage includes the provision of supplementary information that may assist the user in understanding the document data and/or confirm the content of the document. Yet another advantage of the method may include reducing usage of paper.

Before the step of generating the signed document, performing the selected one or more routines may include allowing to receive an acceptance of the supplementary information by the user at the user interface.

The method may include determining a document type of the electronic document based on the one or more predetermined features.

The supplementary information may include one or more of the following: one or more terms and conditions associated with the predetermined features; and a description associated with the terms or conditions.

In the method, generating the signed electronic by associating the electronic document with the signature may include one or more of: updating the electronic document with the signature; and creating a new electronic file with the signature; and storing a signature in a datastore and associating the stored signature with the electronic document.

In the method, the step of identifying one or more predetermined features in document content data may include: comparing one or more text strings in the document data with one or more reference text strings from a datastore; and identifying as said one or more predetermined features in document content data, the one or more text strings in the said document content data that match said reference text strings. The datastore may include supplementary information associated with corresponding predetermined features, and the method further includes: retrieving from the datastore, supplementary information associated with the identified predetermined features.

The method may include the steps of receiving, over a communications network, document content data that forms at least part of the electronic document to be signed.

The method may further include the step of storing the signed electronic document in a datastore. The method may also include the step of sending the signed electronic document, over a communications network, to one or more devices.

The method may further include the steps of: requesting user information of the user at the user interface; and receiving user information of the user from the user interface, wherein the step of generating the signed electronic document further includes associating the electronic document with the user information.

The method may include identifying a location of a signature area in the electronic document, and wherein the step of generating the signed electronic document further includes associating the signature with the location of the signature area in the electronic document. The method may further include: determining a size of the signature area; and scaling the signature to suit the size of the signature area.

The method may include the step of including complementary data into markup language of the signed electronic document, wherein the complementary data includes one or more of the following: user information; supplementary information; an indication of acceptance of the supplementary information; document type; location data of the system; location data of the user interface; and time associated with one or more of the steps of the method.

There is also disclosed a computer-implemented method performed by a server for generating a signed electronic document, the server in communication with at least one other device over at least one communications network, the method including: receiving, over the communications network, document content data that forms at least part of an electronic document to be signed; identifying one or more predetermined features in document content data; selecting, based on the one or more identified features, one or more routines from a plurality of routines, where at least one of the one or more routines defines supplementary information associated with one or more predetermined features; performing the selected one or more routines that includes sending, over the communications network, supplementary information to the client device to provide at a user interface of the client device a representation of the supplementary information, where the representation of the supplementary information is in addition to a representation of the electronic document at the user interface of the client device, receiving, over the communications network, a signature of a user from the client device; and generating the signed electronic document by associating the electronic document with the signature.

There is also disclosed a computer-implemented method performed by a client device for receiving and sending information for generation of a signed electronic document, the client device in communication with a server over a communications network, the method including: receiving, over a communications network, document content data that forms at least part of an electronic document to be signed and supplementary information associated with one or more predetermined features in the document content data; providing, at a user interface of the client device, a representation of supplementary information, where the representation of the supplementary information is in addition to a representation of the electronic document at the user interface; receiving a signature of a user at the user interface; and sending, over a communications network, the signature of the user to the server for generation of the signed electronic document by associating the electronic document with the signature.

There is also disclosed a computer system for generating a signed electronic document, the system including at least a first processing device to: identify one or more predetermined features in document content data, wherein the document content data forms at least part of an electronic document to be signed; select, based on the one or more identified features, one or more routines from a plurality of routines, where at least one of the one or more routines defines supplementary information associated with one or more predetermined features; perform the selected one or more routines to provide at a user interface a representation of the supplementary information, where the representation of the supplementary information is in addition to a representation of the electronic document at the user interface; receive a signature of a user at the user interface; and generate the signed electronic document by associating the electronic document with the signature.

There is also disclosed a computer server for receiving a signature over a communications network and generating a signed electronic document, the server including at least a first processing device to: receive, over the communications network, document content data that forms at least part of an electronic document to be signed; identify one or more predetermined features in document content data; select, based on the one or more identified features, one or more routines from a plurality of routines, where at least one of the one or more routines defines supplementary information associated with one or more predetermined features; perform the selected one or more routines that includes sending, over the communications network, supplementary information to the client device to provide at a user interface of the client device a representation of the supplementary information, where the representation of the supplementary information is in addition to a representation of the electronic document at the user interface of the client device; receive, over the communications network, the signature of a user from the client device; and generate the signed electronic document by associating the electronic document with the signature.

There is also disclosed a client device for sending, over a communications network, a signature to a computer server for generation of a signed electronic document, the client device including a second processing device to: receive, over a communications network, document content data that forms at least part of an electronic document to be signed and supplementary information associated with one or more predetermined features in the document content data; provide, at a user interface of the client device, a representation of supplementary information, where the representation of the supplementary information is in addition to a representation of the electronic document at the user interface; receive the signature of a user at the user interface; and send, over a communications network, the signature of the user to the server for generation of the signed electronic document by associating the electronic document with the signature.

A computer system for generating a signed electronic document may include the computer server and the client device described above.

There is also disclosed a computer program including machine-executable instructions to cause a processing device to perform one or more of the methods described above.

### BRIEF DESCRIPTION OF DRAWINGS

Examples of the present disclosure will be described with reference to:

FIG. 1 is a schematic diagram of an example system for generating a signed electronic document;

FIG. 2 is a schematic diagram of another example computer system for generating a signed electronic document that includes a computer server in communication with a client device over a communications network;

FIG. 3 is a flowchart of a computer-implemented method for generating a signed electronic document;

FIG. 4 is another flow chart of a computer-implemented method for generating a signed electronic document that includes methods performed by a computer server and a client device;

FIG. 5 illustrates a visual representation of a screensaver displayed on the user interface of the client device;

FIG. 6 illustrates a visual representation of an unsigned electronic document displayed on the user interface;

FIG. 7 illustrates a visual representation of supplementary information displayed on the user interface;

FIG. 8 illustrates a visual representation of the supplementary information confirmed by a user on the user interface;

FIG. 9 illustrates a visual representation of the supplementary information and a signature of the user on the user interface;

FIG. 10 illustrates a visual representation of a signed electronic document on the user interface;

FIG. 11 illustrates a visual representation of the unsigned electronic document on a display of an operator device;

FIG. 12 illustrates a visual representation of a print dialog on the display of the operator device;

FIG. 13 illustrates an example of a data structure in a data store, including a plurality of routines; and

FIG. 14 illustrates an example of a processing device.

### DESCRIPTION OF EMBODIMENTS

### Overview of the System for Generating a Signed Electronic Document

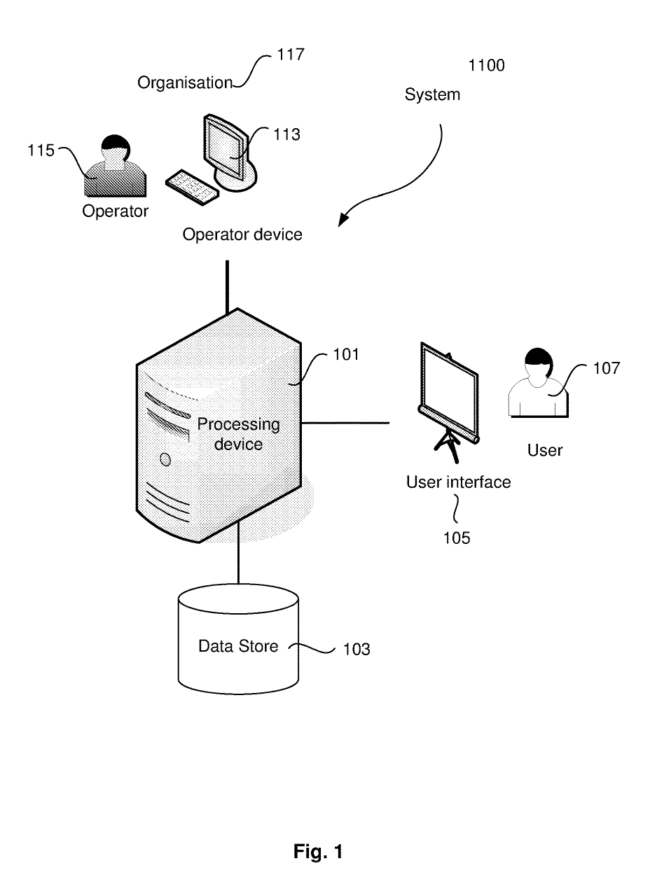

An example computer system 1100 for generating a signed electronic document is illustrated in FIG. 1. The system 1100 includes a first processing device 101 which in turn has access to an associated data store 103. The system 1100 also includes one or more user interfaces 105 to facilitate interaction between user(s) 107 and the system 1100.

The user interface 105 may provide a representation of electronic documents and/or other information to the user 107. The user interface 105 may be in the form of a touchscreen display that can provide one or more visual images to represent the electronic documents and/or other information to the user 107. The user interface 105 also allows the user 107 to receive a signature of the user 107. Thus the user interface 105 may be a touchscreen display that receives touch input from a user 107 such as finger gestures from the user 107.

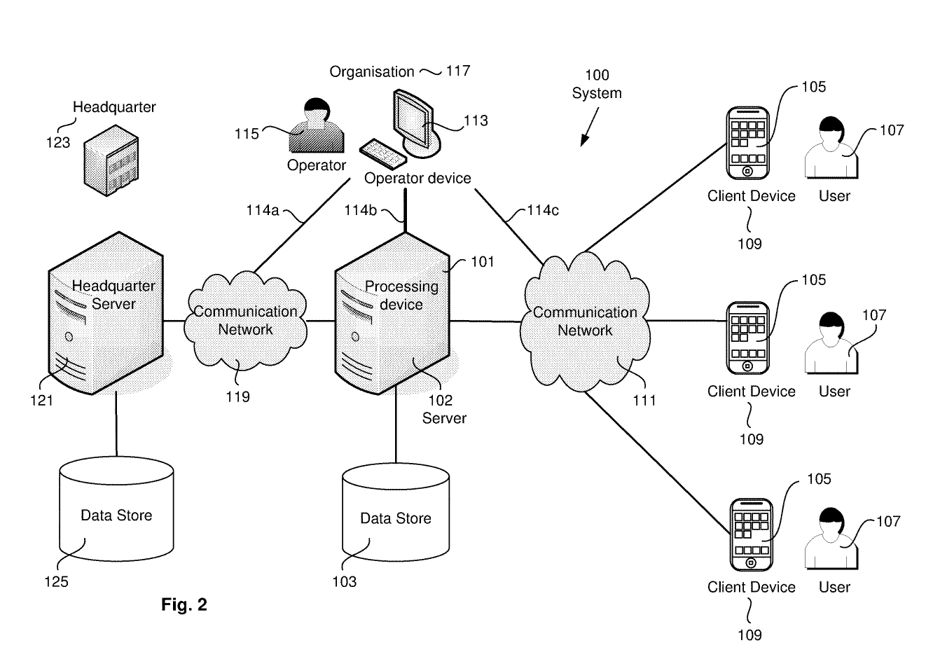

Another example computer system 100 is illustrated in FIG. 2 which shows a computer system 100 for generating a signed electronic document over a communications network 111. The example computer system 100, like the example illustrated in FIG. 1, includes a first processing device 101, a data store 103, and one or more user interfaces 105. The first processing device 101 may be part of a local server 102 that is in communication, via a first communications network 111, with one or more client devices 109. The user interface 105 may be part of the one or more client devices 109. The first communications network 111 may be a local area network where the local server 102 and client devices 109 are located in a limited geographical area. Other examples of communication networks may include a wireless local area network, wide area networks, cellular networks, etc.

The first processing device 101 may also be in communication with an operator device 113 wherein the operator device 113 allows an operator 115 of an organisation 117 to interact with the system 100. The operator device 113 may be located in or near the limited geographical area. The operator device 113 may be in communications 114 with the first processing device via 114c the first communications network 111 and/or by a separate communications means 114a, 114b, such as another communications network 119, or a communications link 114b.

The first processing device 101 may also be in communication, via a second communications network 119, to a headquarter server 121 associated with a headquarter 123 remote from the organisation 117. The second communications network 119 may be a wide area network. The headquarter server 121 has access to a data store 125. The headquarter server 121 may also be in communication with the operator device 113 via the second communications network 119.

### Brief Description of the Method for Generating a Signed Electronic Document

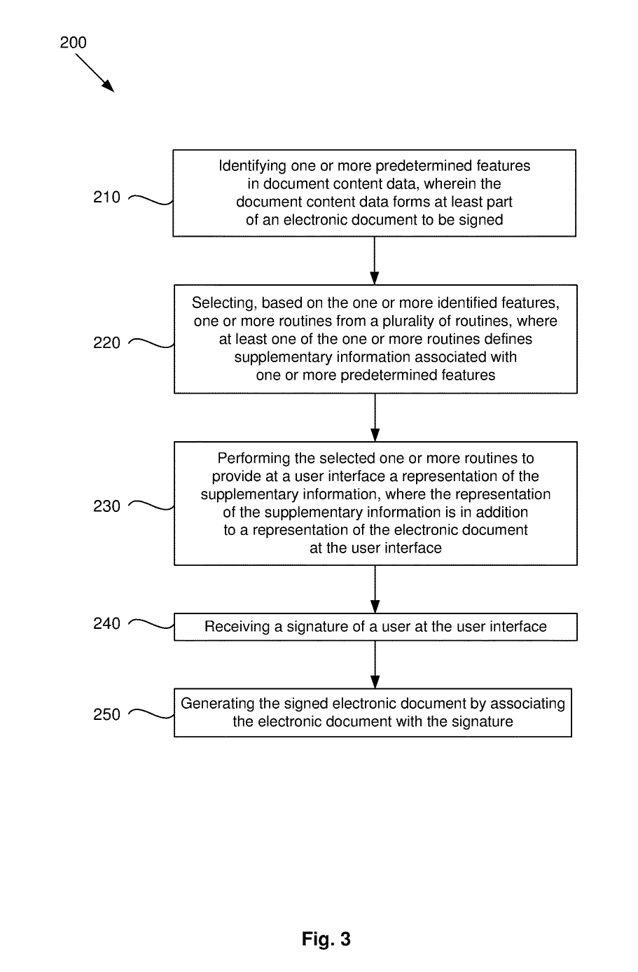

A brief description of a computer-implemented method 200 for generating a signed electronic document will now be described with reference to the flow chart in FIG. 3 which shows:

At block 210, the method includes identifying one or more predetermined features in document content data, wherein the document content data forms at least part of an electronic document to be signed. The document content data may include text, symbols, images, etc, contained in the electronic document and apparent in a representation of the document. The predetermined features may include one or more keywords, text strings, or other identifiable feature(s) in the document content data.

At block 220, the method includes selecting, based on one or more identified features, one or more routines from a plurality of routines, where at least one of the one or more routines defines supplementary information associated with one or more predetermined features. In one non-limiting example the method selects a routine based on a predetermined feature, such as a keyword, that was identified in the document content data. The selected routine, in turn, defines supplementary information which may include, for example, a description or an explanation associated with that keyword.

At block 230, the method includes performing the selected one or more routines. Performance of the routine includes providing at the user interface 105 a representation of the supplementary information, where the representation of the supplementary information is in addition to a representation of the electronic document at the user interface 105. In one non-limiting example, this includes displaying on the user interface 105 the supplementary information, such as the description or explanation associated with the keyword. A representation of the electronic document is also provided at the user interface 105. In some non-limiting examples, providing the representation of the supplementary information and the representation of the electronic document at the user interface may be done concurrently, consecutively, or in other orders either before and/or after step 230.

At block 240, the method includes receiving a signature of a user 107 at the user interface 105. In one non-limiting example this may include a user 107 using a finger gesture to input his or her signature on a touchscreen. In another non-limiting example, this may include a user 107 using an electronic touch pen to provide a signature.

At block 250, a signed electronic document is generated by associating the electronic document with the received signature. In one non-limiting example, this includes creating a new electronic document with the at least part of the document content data and the signature. In another non-limiting example, this includes updating an existing electronic document to include the signature. In yet another non-limiting example, this includes storing, in a data store, the signature and storing a reference to the electronic document to associate the signature with the stored signature.

Thus the method 200 allows a representation of the electronic document to be provided, via the user interface 105, to the user 107 for review. It also provides supplementary information, associated with one or more predetermined features in the document content data, to the user 107 for review. An advantage of the supplementary information is that it may provide additional detail(s), or draw the user's 107 attention to particular detail(s), associated with the predetermined features that are present in the document content data of the electronic document. In one non-limiting example, the electronic document may be a record of a contract, and the supplementary information may be an explanation of a particular clause, or terms and conditions, of the contract. In another non-limiting example, the supplementary information may include repeating, or requesting confirmation of a particular clause, or terms and conditions, of the contract.

The method 200 may also facilitate the user to recognise and understand dynamic changes to particular detail(s). For example, if part of a commonly used document changes, the method 200 may provide supplementary information that draws particular attention to the changes so that the user 107 does not overlook these changes. By performing this method on a computer, the display of supplementary information may be automated. This may advantageously reduce the likelihood of the user 107 overlooking such changes.

Furthermore, the by performing the method on a computer, changes to the form or supplementary information may be more easily managed. For example, changing the document data or the related supplementary information for a large number of documents may be automated.

The method 200 also allows the user 107 to provide a signature, at the user interface 105, where the signature is then used to generate a signed electronic document. The use of the computer system may allow generation of a signed electronic document without printing and/or scanning a hard copy of the electronic document.

The method 200 described above may be performed by the processing device 101.

### Brief Description of the Method of Generating a Signed Electronic Document Over a Communications Network

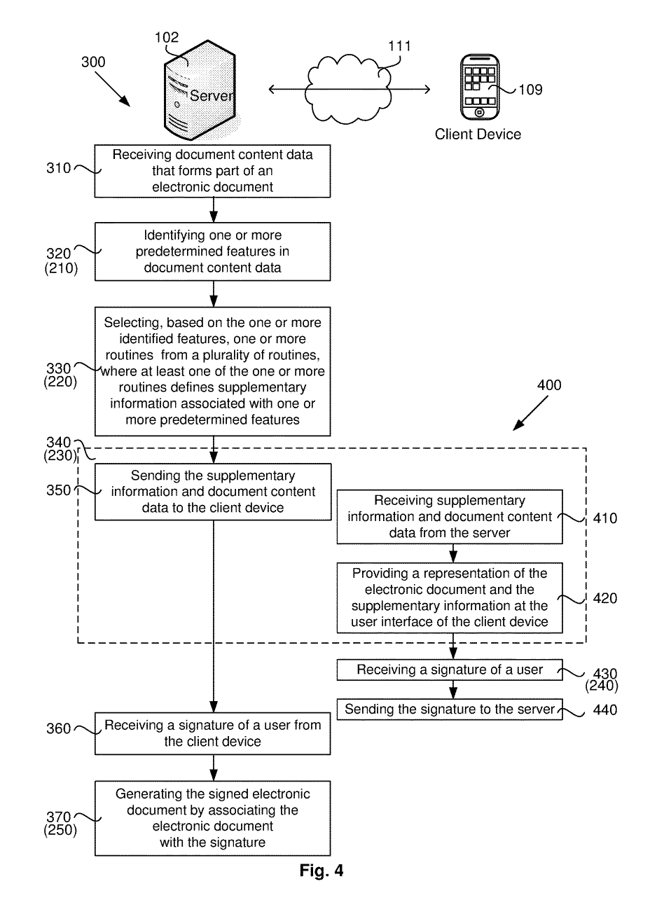

A method of generating a signed electronic document may also be performed over a communications network 111. A brief description of computer-implemented methods 300 and 400 for generating a signed electronic document over a communications network 111 will now be described with reference to FIGS. 2 and 4. The method 300 is performed by a server 102 (having processing device 101) which is in communication with the client device 109 that performs the method 400. The methods 300 and 400 will be described with reference to the steps in the flowchart in FIG. 4 which shows:

At block 310 the server 102 receives document content data that forms part of an electronic document to be signed. The server 102 may receive the document content data from the data store 103, the operator device 113, the headquarter server 121, and/or the data store 125 associated with the headquarter server 121.

At block 320 the server 102 identifies one or more predetermined features in the document content data. This is similar to the step at block 210 described above.

At block 330 the server 102 selects, based on one or more identified features, one or more routines from a plurality of routines, where at least one or more routines defines supplementary information associated with one or more predetermined features. This is similar to the step at block 220 described above. In some non-limiting embodiments, the routines may be retrieved from the data store 103, 125.

At block 340, one or more selected routines are performed. The one or more selected routines may be performed by the server 102 and/or the client device 109. In the example illustrated in FIG. 4, the one or more routines include step 350 performed by the server 102 and steps 410 and 420 performed by the client device 109. The step in block 340 may be similar to the step at block 230 described above.

The server 102 performs the one or more selected routines at block 340. The one or more routines include sending 350, over the communications network 111, supplementary information to the client device 109. The method 300 may also include sending document content data to the client device 109, either as part of the one or more selected routines or as a separate step in the method 300.

The client device 109 performs one or more selected routines at block 340. At block 410 the client device 109 receives, over the communications network 111, document content data and the supplementary information sent from the server 102.

At block 420 the client device 109 provides, at a user interface 105, a representation of supplementary information, where the representation of supplementary information is in addition to a representation of the electronic document at the user interface 105. The user interface 105 may be a touch screen. Providing the representation of the supplementary information and representation of the electronic document at the user interface 105 of the client device 109 may, in one non-limiting example, may be done by displaying the representation at the user interface 105 as described above in the step at block 230.

At block 430 the client device 109 receives a signature of the user 107 at the user interface 105. This is similar to the step at block 240 described above.

At block 440 the client device 109 sends, over the communications network 111, the received signature of the user 107 to the server 102. It is to be appreciated that the received signature may be sent to the server 102 in various formats, including an image file, or other digital representation of the signature.

At block 360 the server 102 receives, over the communications network 111, the signature of the user 107 from the client device 105.

At block 370 the server 102 generates the signed electronic document by associating the electronic document with the signature. This is similar to the step at block 250 described above.

A more in depth description of the method 200, 300 and 400 will now be described.

Receive Document Data that Forms Part of an Electronic Document (310)

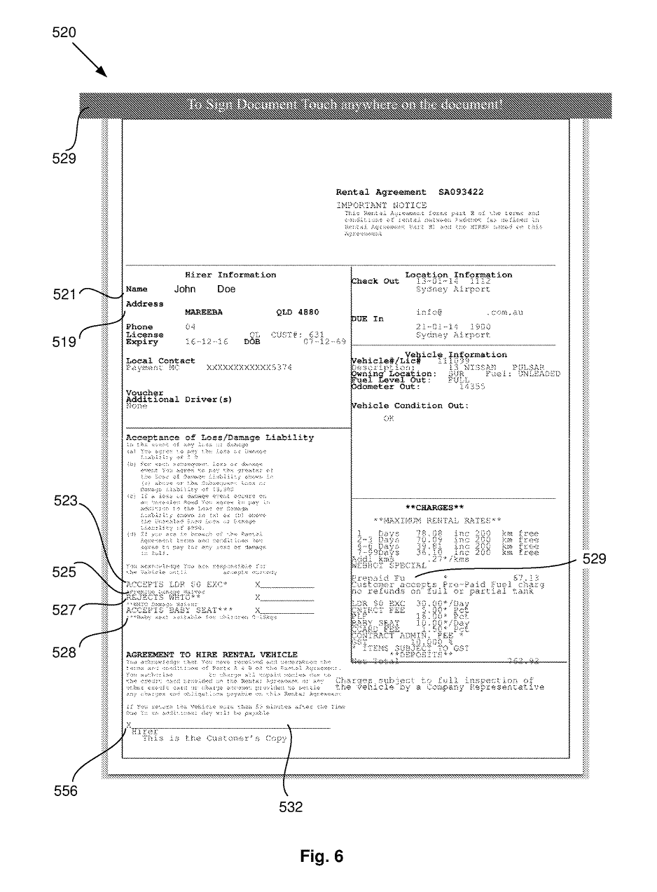

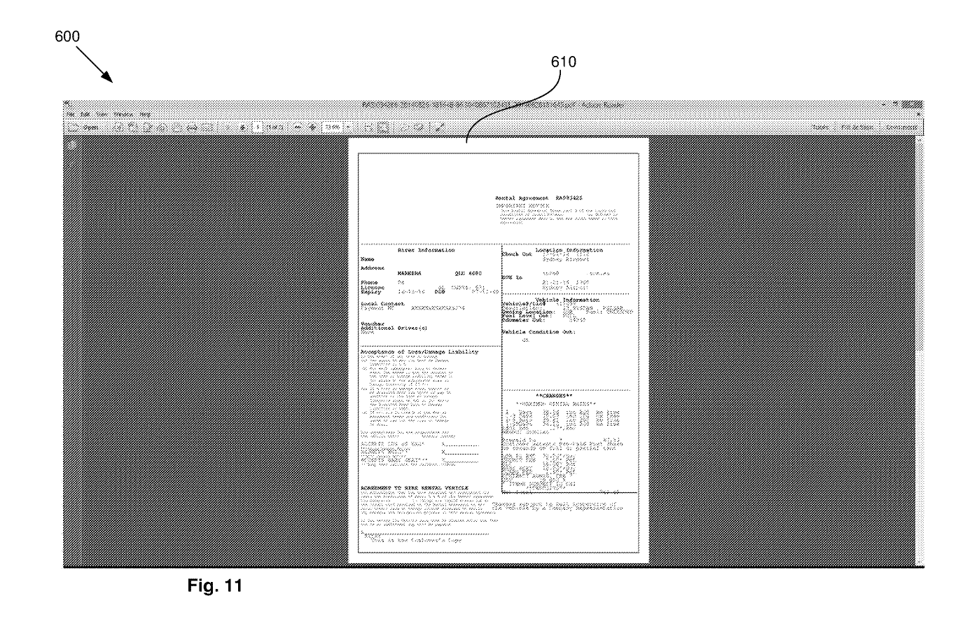

In the example described below, the electronic document is in the form of a rental agreement, as represented in FIGS. 6 and 11. However it is to be appreciated that other forms of electronic documents that can, or require, a signature may be used with the described method. Such documents may include, but not limited to agreements, deeds, contracts, transactions, statements, declarations, letters, emails and other correspondence, etc.

The electronic document (or the document content data thereof which will be described below) may be created at the operator device 113. For example, an operator at an organisation 117 may create the rental agreement at the operator device 113, such as by typing letters, words, and sentences on a keyboard and/or selecting predefined text. The rental agreement 610 (being the electronic document) may be represented at a display 600 of the operator device 113 as shown in FIG. 11.

The electronic document may be previously created and stored in the data store 103. The operator 115 may then request the electronic document from the data store 103 via the server 102 or a communications network (not shown). The previously stored electronic document may be a proforma document that requires population of fields or selection of particular information. For example, the name and address of the user 107 and/or other information specific to the rental agreement such as date, particular terms and conditions, specific item rented, etc.

The electronic document may also be created, entirely or in part, at a location remote from the location of the organisation 117. For example, a headquarter server 121 at a headquarter 123 may include processing device(s) to generate the electronic documents. This may include the headquarter server 121 accessing information from a headquarter datastore 125. This may be useful for businesses with multiple locations and where a headquarter server 121 may facilitate creation of uniform, consistent, and up-to-date electronic documents. The electronic document created at the headquarter server 121 may be sent, via the communications network 119, to the operator device 113. In addition or alternatively, the electronic document created at the headquarter server 121 may be sent, via the communications network 119, to the processing device 101 and/or server 102, which in turn may provide the electronic document or representation thereof to the operator 115 of the operator device 113.

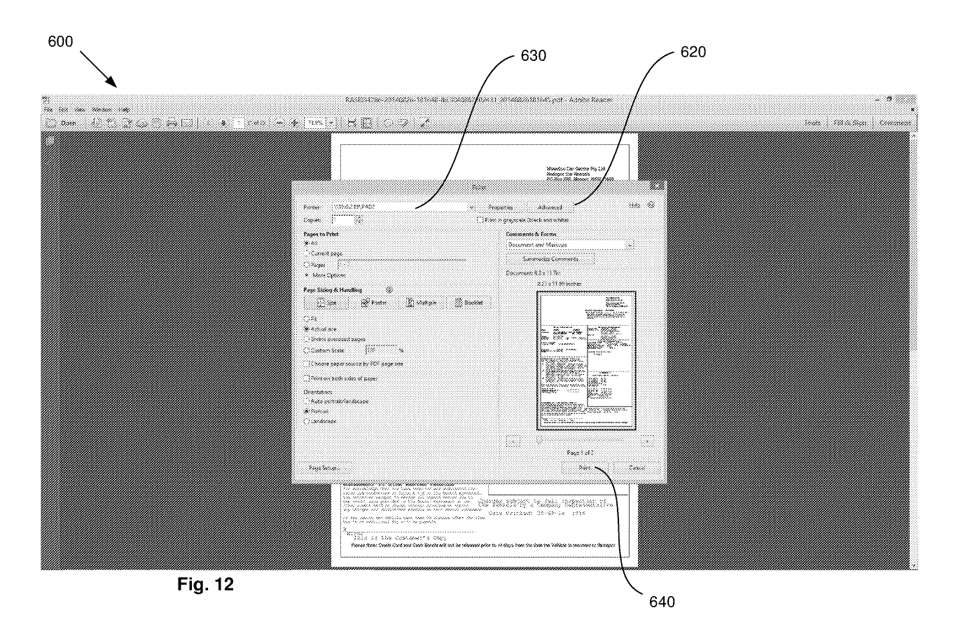

Once the operator 115 is satisfied with the electronic document 610 represented at the display 600, the operator 115 may then cause the electronic document to be received by the first processing device 101 and/or server 102. In the illustrated embodiment of FIG. 12, the operator 115 may send the electronic document to the processing device 101 and/or server 102 via a virtual printer through a print dialog 620. Thus the operator 115 may select to print the electronic document to an identifier linked to the processing device 101, server 102, user interface 105 and/or a user device 109. In the embodiment illustrated in FIG. 12 the identifier 630 is “IPAD2” which identifies the user device 109. On selection of the print icon 640 the electronic document is sent from the operator device 113 to the processing device 101 and/or server 102. The representation of the electronic document 600 will subsequently be displayed at the user interface 105 of the user device 109 that will be discussed in further detail below.

In the above description the method 200, 300 has been described with the processing device 101 and/or server 102 receiving the electronic document from the operator device 113 and/or the headquarter server 121. However, it is to be appreciated that in some alternatives, document data (such as information fields and content) that forms part of an electronic document may be received by the processing device 101 and/or server 102, which in turn creates the electronic document. For example, the processing device 101 and/or server 102 may receive document data such as name, address, product code, etc, and in turn the processing device 101 may create an electronic document based on this information. In one example, the processing device 101 may include multiple modules, including an electronic document creation module to create an electronic document based on document data (as discussed above) and at least one or more other modules for generating a signed electronic document as discussed herein. The electronic document created by the electronic document creation module may be received by the one or more other modules in the processing device 101 to perform the method discussed below.

### Identifying One or More Predetermined Features in Document Content Data (210, 320)

The electronic document includes document content data which may typically include text data. For example, text that includes characters to form words, sentences, etc. Referring to FIG. 6, the document content data includes the text strings:

| | |
|---|---|
| Name John Doe | 521 |
| Address MAREEBA QLD 4880 | 519 |
| ACCEPTS LDR $0 EXC* | 523 |
| *Premium Damage Waiver | 525 |
| REJECTS WHTO** | 527 |
| ACCEPTS BABY SEAT | 528 |
| Prepaid Fu | 529 |

The processing device 101 identifies predetermined features in the document content data. The predetermined feature(s) may include a text string of significance, such as “ACCEPTS LDR $0 EXC*” which indicates some of the particular terms and conditions of the rental agreement denoted by the electronic document.

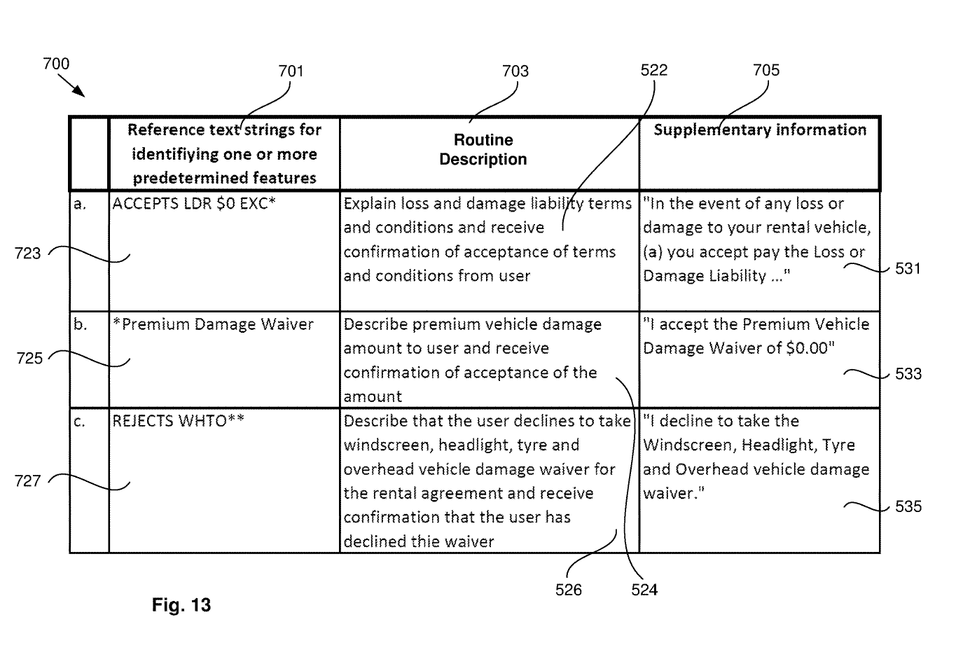

In one embodiment, the processing device 101 identifies the predetermined features in the document content data by comparing the text in document data with one or more reference text strings from the data store 103. If text in the document data matches or is suitably similar to one or more of the reference text strings, the processing device 101 identifies that the document content data has the one or more predetermined feature associated with the reference text string. FIG. 13 illustrates an example of a data structure 700 in the data store 103 containing reference text strings 701, plurality of routines 703 corresponding to the reference text strings 701, and associated supplementary information 705.

In the example illustrated in FIG. 6, the identified predetermined features 523, 525, 527, 528, 529 in the document content data include:

| | |
|---|---|
| ACCEPTS LDR $0 EXC* | 523 |
| *Premium Damage Waiver | 525 |
| REJECTS WHTO** | 527 |
| ACCEPTS BABY SEAT | 528 |
| Prepaid Fu | 529 |

The identified predetermined features determine the selection of routines that will now be discussed below.

### Selecting, Based on Identified Features, One or More Routines (220, 330)

The processing device then selects one or more routines based on the one or more identified features 523, 525, 527, 528, 529, from one or more routines from a plurality of routines (such as those illustrated in the data structure in FIG. 13). In the illustrated embodiment, the routines include the following:
The predetermined feature “ACCEPTS LDR $0 EXC*” 523 (corresponding to reference text string 723) has a routine 522 that includes defining supplementary information 531 for the user. The supplementary information 531 to the user includes an explanation of the loss and damage liability terms and conditions of the rental agreement. The routine 522 also includes receiving confirmation from the user that he or she accepts the supplementary information, being the loss and damage terms and conditions.
The predetermined feature “*Premium Damage Waiver” 525 (corresponding to reference text string 725) has a routine 524 that includes defining supplementary information 533 to the user including a description of the premium vehicle damage waiver amount (in this case “$0.00”) for the rental agreement. The routine 524 also includes receiving confirmation from the user that he or she accepts the waiver amount.
The predetermined feature “REJECTS WHTO**” 527 (corresponding to reference text string 727) has a routine 526 that includes defining supplementary information 535 to the user including a description that the user declines to take windscreen, headlight, tyre and overhead vehicle damage waiver for the rental agreement. The routine 526 also includes receiving confirmation from the user that he or she has declined to take this waiver.
The predetermined feature “ACCEPTS BABY SEAT” 528 has a routine that includes defining supplementary information 537 to the user including a description that the user accepts to receive a baby seat as part of the rental agreement. The routine also includes receiving confirmation from the user that he or she accepts to receive a baby seat in the rental agreement.
The predetermined feature “Prepaid Fu” 529 has a routine that includes defining supplementary information 539 to the user including a description that the user accepts the pre-paid fuel charge option and an explanation of the terms of accepting that option. The routine also includes receiving confirmation from the user that he or she accepts to receive a baby seat in the rental agreement.

The routines may include computer implemented instructions stored in the data store 103, 125 that are executed by the processor 101 and/or the client device 109, such as individual sub-programs to perform particular tasks. FIG. 13 illustrate a data structure showing the relationship between routines 703, reference text 701 and supplementary information 705 that may be stored in a manner associated with corresponding reference text strings 701 and supplementary information 705.

### Performing the Selected One or More Routines (230, 340)

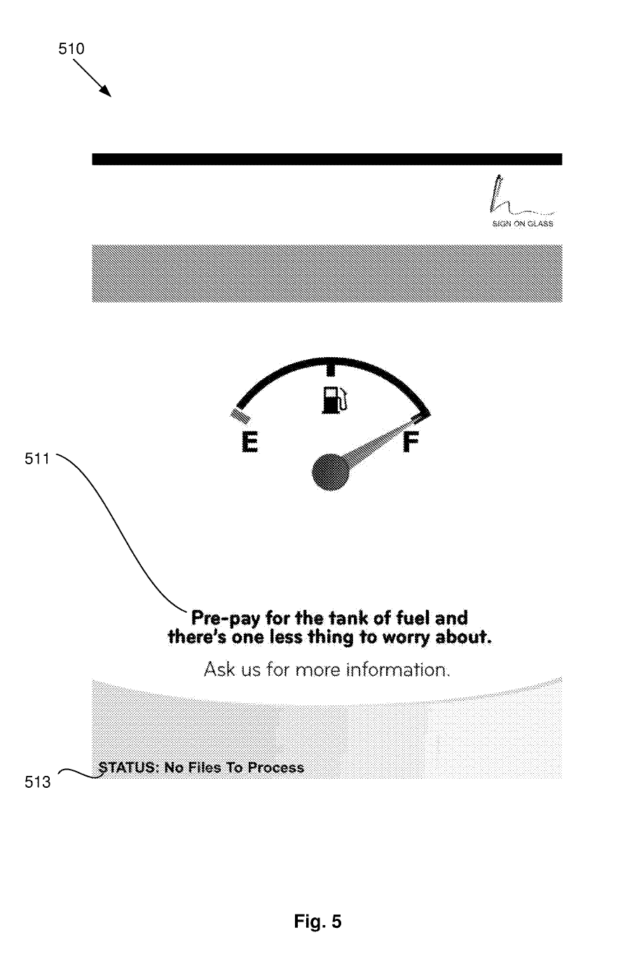

Performing 230, 340 the selected one or more routines 522, 524, 526 will now be described with reference to FIGS. 5 to 8.

FIG. 5 shows is a visual representation 510 of the user interface 105 at the client device 109 before the one or more routines are performed and before the client device 109 receives supplementary information or document content data from the server 102. The user interface 105 illustrates a screensaver including an advertisement 511. The visual representation 510 also includes a status indicator 513 that indicates “no files to process”.

After the preceding step of selecting 220, 330 the one or more routines 522, 524, 526 the method includes the step of performing 230, 340 the selected one or more routines 230, 340. In this example, the selected routines 522, 524, 526 include defining supplementary information 531, 533, 535 that needs to be provided to the user interface 105. This may include accessing the data store 103, 125 for at least some of the supplementary information. Subsequently, the supplementary information 531, 533, 535 and document content data is sent from the server 102 to the client device 109.

The client device 109 receives 410 the supplementary information and document content data from the server 102.

The client device 109 after receipt of the supplementary information and document content data, provides 420 a representation 520 of the electronic document at the user interface 105 as shown in FIG. 6. This representation 520 of the electronic document allows the user 107 to review the complete document, similar to how a person would review a hard copy of a document.

Once the user 107 is satisfied with the electronic document, the user can proceed to the next step by interacting with the user interface 105. In this embodiment, the user interface 105 is a touchscreen and the interaction includes the user providing a touch input to the user interface 105. To guide the user 107 in this process, a prompt 529 provides instructions to the user 107 to interact with the user interface 105.

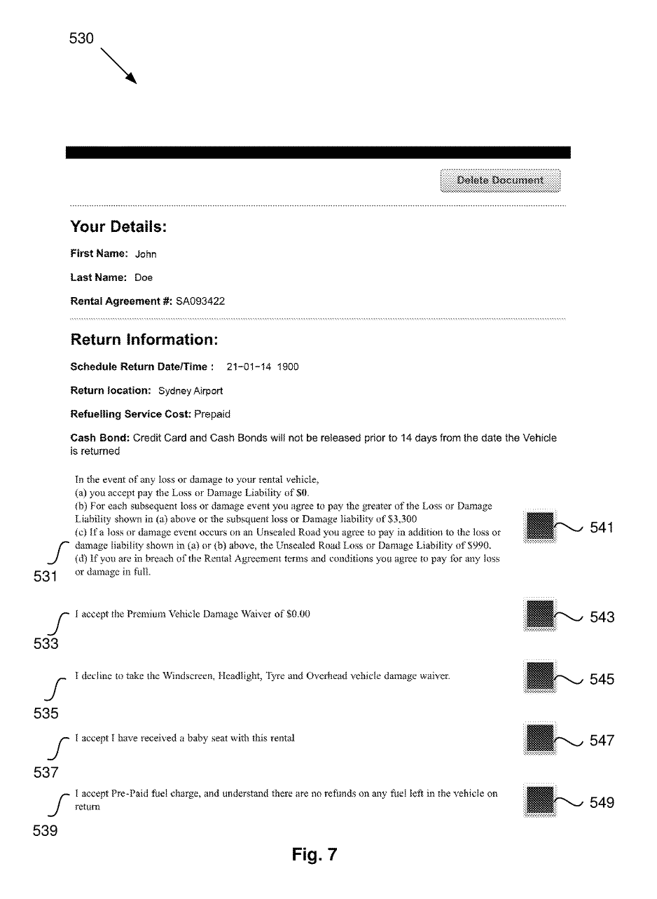

The client device 109, in response, provides a representation 530 of the supplementary information at the user interface 105 as best illustrated in FIG. 7. The representation 530 of supplementary information 531, 533, 535, 537, 539 associated with the identified predetermined features 523, 525, 527, 528 and 529 respectively.

For example, supplementary information 531 includes an explanation of the loss and damage liability terms and conditions of the rental agreement. This supplementary information is associated with the predetermined feature “ACCEPTS LDR $0 EXC*” 523 that was identified in the document content data. The supplementary information 531 may include an explanation that is more detailed than the associated predetermined feature 523. This may assist the user 107 to better understand particular terms and conditions of the rental agreement. Furthermore, this may allow the original electronic document to be more succinct without having lengthy explanations of the terms and conditions.

Each of the supplementary information 531, 533, 535, 537, 539 includes a corresponding check box 541, 543, 545, 547, 549 for the user 107 to check. The check boxes allow the user 107 to actively acknowledge each of the supplementary information and may, in this example, be taken as confirmation of the particular terms and conditions of the rental agreement. This may be performed by receiving a touch input at each of the check boxes on the user interface 105.

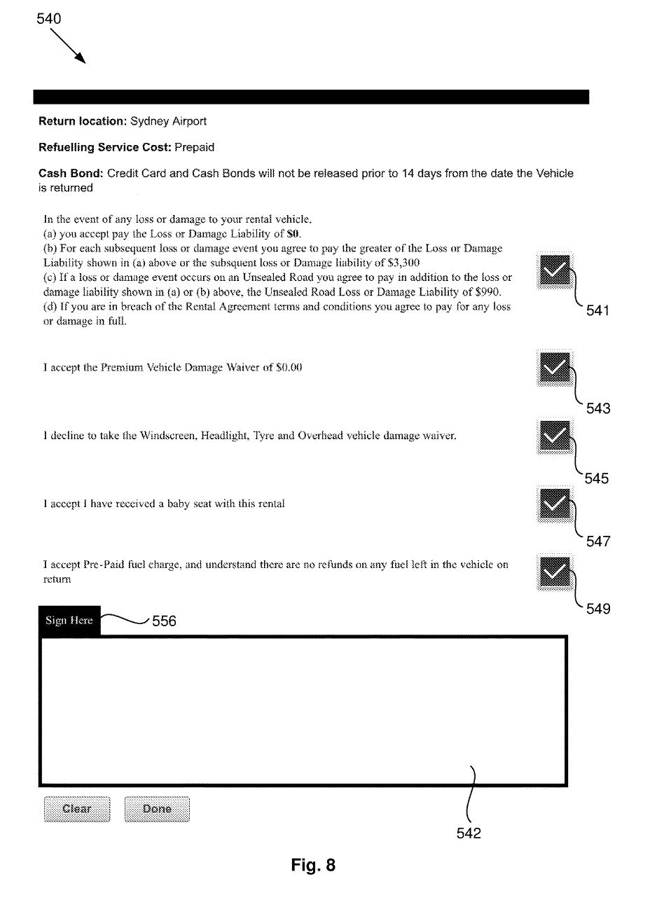

FIG. 8 illustrates a representation 540 on the user interface 105 with all of the check boxes 541, 543, 545, 547 and 549 selected by the user 107. This may indicate a situation where the user 107 has confirmed all the supplementary information 531, 533, 535, 537, 539. As noted above, receiving confirmation of the supplementary information may be part of the one or more selected routines 522, 524, 526.

The confirmation of the supplementary information may be sent from the client device 109 to the server 102 when the corresponding check boxes are selected by the user 107.

In another embodiment, the method may include only allowing subsequent steps of the method to continue if the user 107 selects each and every one of the check boxes. As illustrated in FIG. 8, a signature box 542 is provided when all the check boxes 541, 543, 545, 547, 549 have been selected. This is in contrast to FIG. 7 where the check boxes have not been selected and consequently, no signature box 542 is provided.

### Receiving a Signature of a User (430, 440, 360)

Once the user 107 is satisfied with the electronic document as represented 520 in FIG. 6 as well as the supplementary information as confirmed in FIG. 8, the user 107 may then sign the electronic document.

As shown in FIG. 8 a signature box 542 is provided in the representation 540 on the user interface 105 for the user 107 to input their signature. In one example, the touchscreen of the user interface 105 may receive 240, 430 a signature 551 of the user 107 by finger gestures. In another example, the user 107 may use a stylus on the user interface 105 to provide the signature. In yet another example a further user interface, separate from the touchscreen of the user interface 105, may receive the signature.

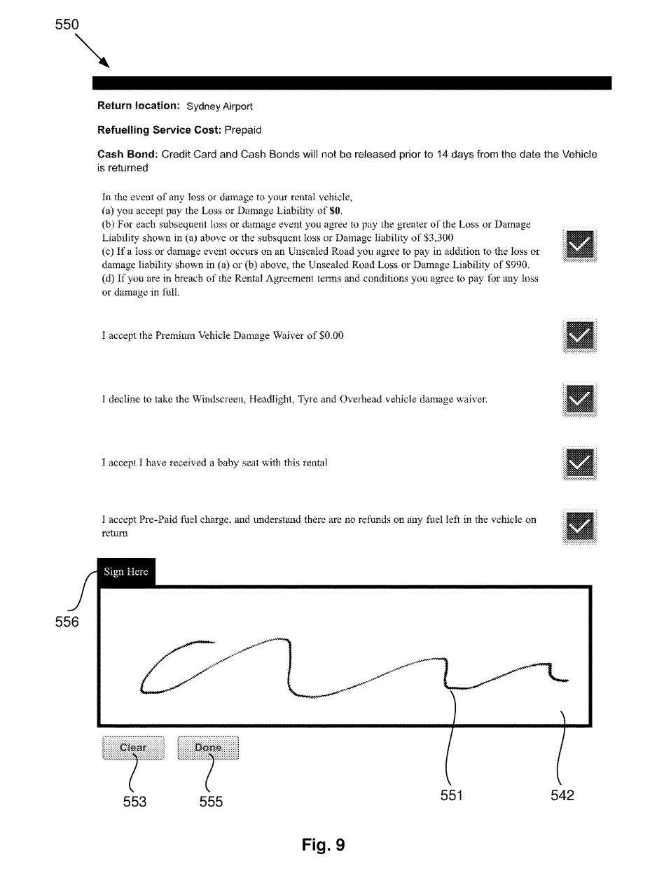

FIG. 9 illustrates a representation 550 on the user interface 105 after the signature 551 is received from the user 107. This gives the user 107 an opportunity to review his or her signature 551 in the signature box 542. If the user 107 is not satisfied, the user can interact with the “Clear” button 553 to clear the signature 551 from the signature box 542. If the user 107 is satisfied with the signature, the user 107 can interact with the “Done” button 555 to submit the signature.

After the user 107 interacts with the “Done” button 555, the client device 109 sends 440 the signature to the server 102. The client device 109 may also send other information to the server, including information relating to the selected routines, such as the user 107 confirming the supplementary information. The client device 109 may also send other information, such as a time and date associated with the signature, the location of the client device, name of the user 107 and/or information that the user 107 may have provided to the client device 109.

The server 102, in turn, receives 360 the signature from the client device 109 for generation of the signed electronic document which will be discussed in further detail below. The server 102 may also receive other information sent from the client device 109, such as confirmation of the supplementary information and other information as discussed above.

Generating the Signed Electronic Document by Associating the Electronic Document with the Signature (250, 370)

The next step is generating 250, 370 the signed electronic document by associating the electronic document and the received signature.

In one example, generating 250, 370 the signed electronic document at the server 102 includes the processing device creating a new electronic document with at least part of the document content data and the received signature. The new electronic document may then be stored in the data store 103. The new electronic document may also include additional information, such as information received from the client device 109 including confirmation of supplementary information. The additional information may also include information related to time and/or location, the user 107, client device 109, operator 115, operator device 113, security information, etc.

In another example, generating 250, 370 the signed electronic document at the server 102 includes the processing device 101 updating an existing electronic document to include the signature. The existing electronic document may have been stored in data store 103, 125 or in other memory associated with the server 102. Updating the existing electronic document may include updating the document with additional information as described above.

In yet another example, generating 250, 370 the signed electronic document at the server 102 includes storing the signature in the data store 103, 125 and associating an electronic document with the stored signature. This may include providing in a database, a reference to associate the electronic document and the stored signature. The electronic document and the stored signature may be stored in the same data store 103, 125 or in separate data stores.

### Storage and Distribution of the Signed Electronic Document

After the signed electronic document has been generated 250, 370 the document may be stored or distributed to the parties for viewing and for their records.

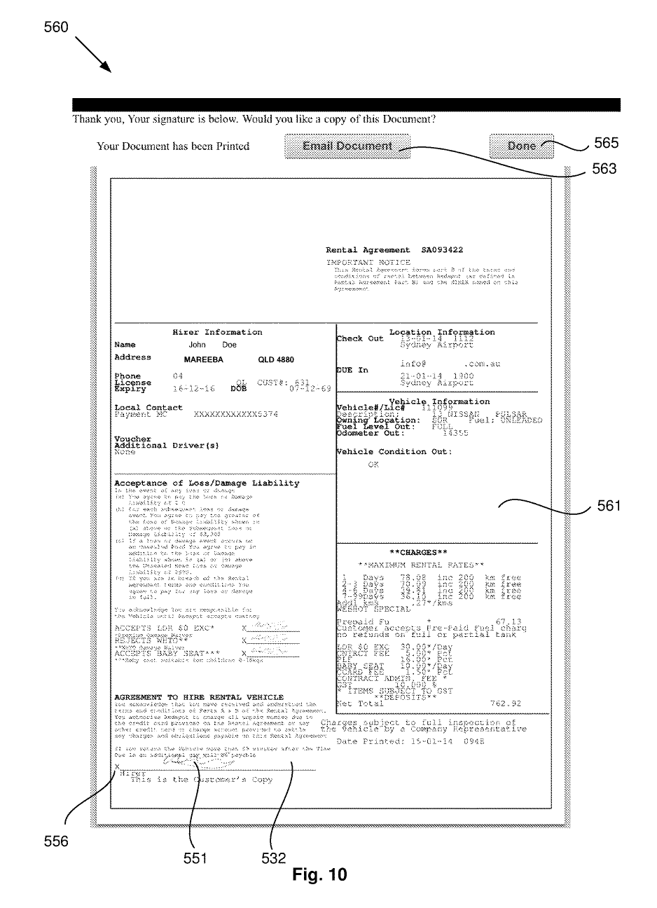

In one example, this includes the server 102 sending the signed electronic document, over the communications network 111, to the client device 109. Referring to FIG. 10, the client device 109 provides a representation 560 at the user interface 105 that includes a representation 561 of the signed electronic document. This allows the user 107 to review the signed electronic document like a user could with a traditional paper document.

The user 107 may be provided with the option to have a copy of the electronic document sent to them for their records. Referring to FIG. 10, an “Email Document” button 563 is provided on the user interface 105 to allow the user to select the option to have the signed electronic document emailed to them for their records. It is to be appreciated that other options could be provided, such as an option to send a copy by regular postal service, an option to print a hard copy, or an option to send a copy to an electronic device of the user (such as a portable electronic device). In yet other examples, the user 107 may elect to have the signed document sent to a third party.

Similarly, the signed electronic document may be sent to the operator device 113 to be viewed by the operator 115. In yet another example, the signed electronic document may be sent to the organisation 117 and/or the headquarter 123.

In one example, the signed electronic documents may be stored locally in the data store 103 as transactions are made. The signed electronic documents 103 may be sent to the headquarter server, via the communication network 119, at selected times which in turn stores the signed electronic documents in the data store 125. In one example, the selected times are during “off peak” times of the communication network 119. This can be useful in instances where there is a low bandwidth through the communication network 119 between the server 102 and headquarter server 121.

### The Electronic Document

### Document Format

The electronic document can be in the form of one or more types of digital formats. In one example, the electronic document (and/or the document content data) is a text file. In one example, the electronic document is in the form of a Portable Document Format (PDF). In another example, the electronic document is in the form of a Microsoft Word document.

In some examples, the electronic document is an image file. In some examples, text extraction software is used to extract text to provide the document content data.

It is to be appreciated that the above mentioned system and method may use one or more combinations of document or file formats. It is also to be appreciated that the generated electronic document may be any one or more of the above mentioned document or file formats.

In one example, the generating the signed electronic document further includes including complementary data into the markup language of the signed electronic document. The complementary data may include one or more of the following:
user information, such as the name of the user, email address, telephone number, or postal address, etc;
supplementary information;
an indication of acceptance of the supplementary information;
document type;
location data of the system;
location data of the user interface; and
time associated with one or more of the steps of the method.

### Generation of the Signed Electronic Document at the Client Device

In one of the above described embodiments, the step of generating 370 the signed electronic document is performed by the server 102. However, it is to be appreciated that in one alternative, the client device 109 after receiving the signature of the user may generate the signed electronic document using the received document content data and the received signature. After generation of the signed electronic document, the client device 109 may send, over the communication network 111, the signed electronic document to the server 102. The server 102, may in turn, store the signed electronic document in the data store 103 and/or distribute the signed electronic document to the operator device 113, headquarter server 121, data store 125, or a third party. In one example, distribution by the server 102 of the signed electronic document may be performed through the communication network 119.

### Identifying the Signature Area and Scaling of the Signature

The above mentioned method 200, 300 may also include identifying the location and/or size of the signature area 532 in the electronic document.

Referring to FIGS. 6 and 10, the method may include identifying the signature area 532 by a text string, and in this example the text string “x” 556 followed by a horizontal line. The size of the signature area 532 may be determined by the length of the horizontal line and the white space above.

In an alternative example (not illustrated) the signature area may include a rectangular border at the perimeter. The size and location of the signature area may be determined by identifying the corners of the signature perimeter.

In one form, the Cartesian coordinates of the corners of the signature area 542 are used to provide the location and size of the signature area 542. However, it is to be appreciated that other methods or combination of methods may be used to provide size and/or location information of the signature area. For example, the signature area may be represented by vectors from a reference point.

In one alternative, or as a supplement, the method may include comparing text strings in the document data to identify the location of the signature area. For example, the text string “sign here” or “signature” may be indicative that a signature location 532 or signature box is proximal to the text string.

Identification of the size and location of the signature location or signature box assists generation of the signed electronic document as the received signature can be associated with the location of the signature area 532. Furthermore, the received signature may have the size scaled to fit the signature area 532. Scaling may include reducing the size of the signature to fit within the size of the signature area 532. Alternatively, scaling may include increasing the size of the signature to fill at least a predetermined portion of the signature area 532. Referring to the example in FIGS. 9 and 10, the signature 551 in signature area 532 in the representation of the signed electronic document 560 (as shown in FIG. 10) is smaller than the signature 551 in the signature box 542 in the representation 550 (as shown in FIG. 9). This illustrates scaling of the signature 551 to fit within the confines of the signature area 532.

### Variation

Associating Further Information with the Electronic Document

In one variation, the method may further include associating further information with the signed electronic document. The further information may be received by the processing device 101 of the server 102 from the client device 109, operator device 113 or another electronic device. In one example, the further information may include an electronic image, such as a digital photograph that is associated with the signed electronic document. For example, the client device 109 may be associated with a digital camera 109 and the method 400 may include capturing an image of the user 107 from which the signature is received. The method 400 may then include sending the image of the user 107 to the processing device 101. In turn, the processing device may associate the image of the user, being the further information, with the signed electronic document. This may include storing the image of the user 107 in the data store 103 and including a pointer in the signed electronic document to the stored image. This may allow an additional record (in the form of an image) of the identity of the user 107 that signed the document.

In another example, the further information may include an image of a product associated with the signed electronic document. In the case of a rental agreement for a car, it may be desirable to have proof of any damage (or lack thereof) to a vehicle at the time the rental agreement is signed. Therefore the operator device 113, client device 109, or another electronic device, may have a digital camera whereby the camera captures images of the vehicle. The images of the vehicle are then sent to the processing device 101, whereby the method 200, 300 may include associating these images, being further information, with the signed electronic document as well as storing the images.

### Queuing of Multiple Documents

In some circumstances, more than one electronic document may need to be signed by a user 107. In an illustrative example, a company may wish to rent multiple vehicles whereby each vehicle may have a separate and distinct rental agreement (the electronic document) for signing.

Therefore, the operator 115 or user 107 may want to prepare multiple documents ready for review and signing by a user 107. In one example, the method 200, 300 may include the steps identifying 210 one or more predefined features, selecting 220 one or more routines for the multiple documents. These multiple documents may then be stored, or held in a queue at the processing device or client device, until a time the user 107 can review the documents for signature. At such time, the user 107 may enter, via a user interface 105 of the client device 109 a PIN (personal identification number) or password that enables the user 107 to review the documents and sign. This may include releasing the documents held in the queue whereby the processing device 101 performs 230 the one or more routines. The user 107 may then provide the signature at the client device 109 which is then sent to the processing device for associating with the electronic document.

This may be advantageous as it may save the user 107 time by allowing bulk generation of documents, which may then be stored or held in queue for later signature, output and archiving. This may also be advantageous in cases where a user 107 who is authorised to sign may not always be available. For example, an employee of a company may wish to interact with the operator 115 to prepare these documents. After this an authorised user 107, such as an executive of the company, can review and sign the documents at a suitable time.

In some examples, one or more of the electronic documents may have identical predetermined features. For example, the user may wish to rent multiple cars whereby at least some of the terms and conditions for the respective rental agreements are identical. Thus in some circumstances where documents are reviewed by a user 107 in bulk, it may only be necessary to provides a representation of the supplementary information that is common to all the documents once. This may save the user 107 time compared to having to review identical supplementary information (and to provide acceptance of the supplementary information) multiple times.

Therefore in one example, the method 200, 300 may include determining, for multiple documents, whether one or more of the selected routines are identical and/or similar. If so, the method may include performing the identical or similar routine whereby performing that routine satisfies the requirement (if any) for performing the routine for each of the multiple electronic documents.

### Software

There is also disclosed a computer program comprising machine-executable instructions to cause a processing device, such as processor 101, to implement the method 200, 300 described above. The computer program may be stored in memory associated with the processor 101.

There is also disclosed a computer program comprising machine-executable instructions to cause a processor of the client device 109 to implement the method 400 described above. The computer program may be a native application to the client device 109. The computer program performed by the client device 109 may be implemented with HTML5. Advantageously, this allows flexibility as this may allow client devices 109 using different platforms and operating systems to implement the method 400 without requiring a specific application created for the particular client device 109 or operating system

### Processing Device

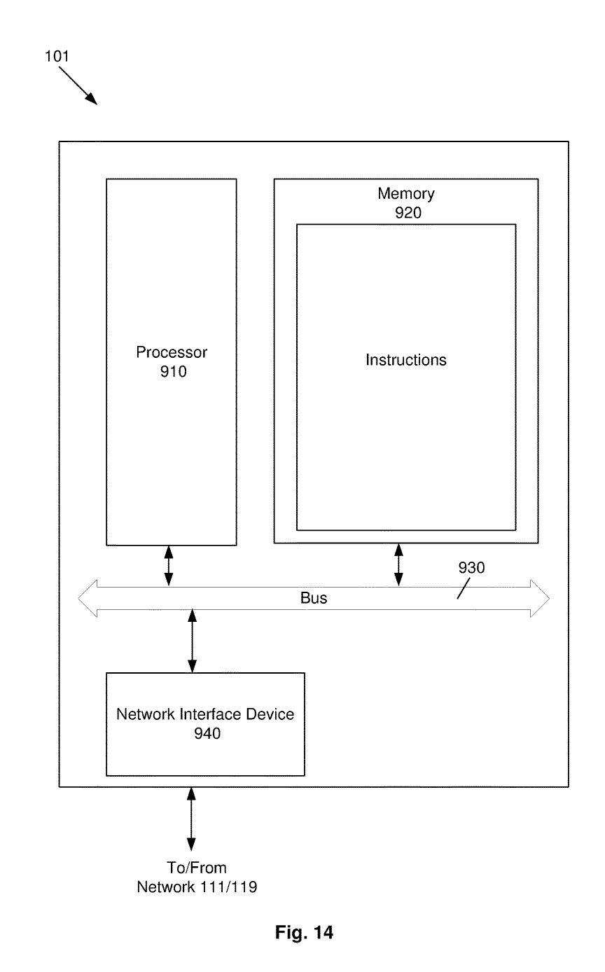

FIG. 14 illustrates an example of a processing device 101 such as one provided at the server 102. The processing device 101 includes a processor 910, a memory 920 and a network interface device 940 that communicate with each other via a bus 930. The memory 920 stores instructions and data for the computer-implemented methods 200, 300 described above, and the processor 910 performs the instructions from the memory 920 to implement the methods 200, 300. The network interface device 940 facilitates communication with the communications network 119, 111. It should be noted that although the processing device 101 is shown as an independent network element, the processing device 101 may also be part of another network element. Further, functions performed by the processing device 101 may be distributed between multiple network elements in FIG. 2, such as at the server 102 and headquarter server 121, and operator device 113.

It is to be appreciated that the client device 109 may also have a similar processing device having a processor, memory, bus and network interface device for communication with the communications network. The client device may also have a user interface 105 that communicates with other components of the client device 109 via the bus.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A computer-implemented method for generating a signed electronic document, the method comprising:
identifying one or more predetermined features in document content data, wherein the document content data forms at least part of an electronic document to be signed;
selecting, based on the one or more identified features, one or more routines from a plurality of routines, where at least one of the one or more routines defines supplementary information associated with one or more predetermined features;
performing the selected one or more routines to provide at a user interface a representation of the supplementary information, where the representation of the supplementary information is in addition to a representation of the electronic document at the user interface;
receiving a signature of a user at the user interface; and
generating the signed electronic document by associating the electronic document with the signature.

2. The computer-implemented method according to claim 1, wherein before the step of generating the signed document, performing the selected one or more routines further comprises:
allowing to receive an acceptance of the supplementary information by the user at the user interface.

3. The computer-implemented method according to claim 1 wherein the routine comprises:
determining a document type of the electronic document based on the one or more predetermined features.

4. The computer-implemented method according to claim 1 wherein the supplementary information comprises one or more of the following:
one or more terms and conditions associated with the predetermined features; and
a description associated with the terms or conditions.

5. The computer-implemented method according to claim 1 wherein the step of identifying one or more predetermined features in document content data comprises:
comparing one or more text strings in the document content data with one or more reference text strings from a datastore; and
identifying as said one or more predetermined features in document content data, the one or more text strings in the said document content data that match said reference text strings.

6. The computer-implemented method according to claim 5, wherein the datastore includes supplementary information associated with corresponding predetermined features, and wherein the method further comprises:
retrieving from the datastore, supplementary information associated with the identified predetermined features.

7. The computer-implemented method according to claim 1 further comprising:
receiving, over a communications network, document content data that forms at least part of the electronic document to be signed.

8. The computer-implemented method according to claim 1 further comprising:
storing the signed electronic document in a datastore.

9. The computer-implemented method according to claim 1 further comprising:
sending the signed electronic document, over a communications network, to one or more devices.

10. The computer-implemented method according claim 1 further comprising:
requesting user information of the user at the user interface; and
receiving user information of the user from the user interface;
wherein the step of generating the signed electronic document further includes associating the electronic document with the user information.

11. The computer-implemented method according to claim 1 further comprising:
identifying a location of a signature area in the electronic document;
wherein the step of generating the signed electronic document further comprises:
associating the signature with the location of the signature area in the electronic document.

12. The computer-implemented method according to claim 11 further comprising:
determining a size of the signature area; and
scaling the signature to suit the size of the signature area.

13. The computer-implemented method according to claim 1 further comprising:
including complementary data into markup language of the signed electronic document, wherein the complementary data includes one or more of the following:
user information;
supplementary information;
an indication of acceptance of the supplementary information;
document type;
location data of the system;
location data of the user interface; and
time associated with one or more of the steps of the method.

14. A computer-implemented method performed by a server for generating a signed electronic document, the server in communication with at least one other device over at least one communications network, the method comprising:
receiving, over the communications network, document content data that forms at least part of an electronic document to be signed;
identifying one or more predetermined features in document content data;
selecting, based on the one or more identified features, one or more routines from a plurality of routines, where at least one of the one or more routines defines supplementary information associated with one or more predetermined features;
performing the selected one or more routines that includes sending, over the communications network, supplementary information to the client device to provide at a user interface of the client device a representation of the supplementary information, where the representation of the supplementary information is in addition to a representation of the electronic document at the user interface of the client device;
receiving, over the communications network, a signature of a user from the client device; and
generating the signed electronic document by associating the electronic document with the signature.

15. A computer-implemented method performed by a client device for receiving and sending information for generation of a signed electronic document, the client device in communication with a server over a communications network, the method comprising:
receiving, over a communications network, document content data that forms at least part of an electronic document to be signed and supplementary information associated with one or more predetermined features in the document content data;
providing, at a user interface of the client device, a representation of supplementary information, where the representation of the supplementary information is in addition to a representation of the electronic document at the user interface;
receiving a signature of a user at the user interface; and
sending, over a communications network, the signature of the user to the server for generation of the signed electronic document by associating the electronic document with the signature.

16. A computer system for generating a signed electronic document, the system comprising at least a first processing device to perform the method according to claim 1.

17. A computer server for receiving a signature over a communications network and generating a signed electronic document, the server comprising at least a first processing device to perform the method according to claim 14.

18. A client device for sending, over a communications network, a signature to a computer server for generation of a signed electronic document, the client device comprising a second processing device to perform the method according to claim 15.

19. A computer system for generating a signed electronic document comprising a computer server according to claim 17.

20. A computer program comprising machine-executable instructions to cause a processing device to perform the method according to claim 1.
